(19) United States
(12) Patent Application Publication
(10) Pub. No.: US 2023/0406633 A1
(43) Pub. Date: Dec. 21, 2023

(54) MANAGEMENT APPARATUS, MANAGEMENT METHOD, AND PROGRAM

(71) Applicant: TOYOTA JIDOSHA KABUSHIKI KAISHA, Toyota-shi (JP)

(72) Inventors: Junya OTA, Edogawa-ku (JP); Yutaro TAKAGI, Edogawa-ku (JP); Kunihiro IWAMOTO, Nagakute-shi (JP); Takatoshi MORIMITSU, Toyota-shi (JP); Uori KOIKE, Saitama-shi (JP)

(73) Assignee: TOYOTA JIDOSHA KABUSHIKI KAISHA, Toyota-shi (JP)

(21) Appl. No.: 18/337,129

(22) Filed: Jun. 19, 2023

(30) Foreign Application Priority Data
Jun. 20, 2022 (JP) 2022-098765

(51) Int. Cl. B65G 1/137; G06Q 10/087

(52) U.S. Cl. CPC B65G 1/1373; G06Q 10/087

(57) ABSTRACT

A management apparatus, a management method, and a program that can suppress inefficient replenishment are provided. A management apparatus includes an information acquisition unit configured to acquire, for each item, frequency information, the frequency information indicating a frequency of consumption, an allocation determination unit configured to determine allocation of the item to a storage container for storing the item based on the frequency of consumption of the item, and an instruction unit configured to instruct a robot to perform an action for replenishing the consumed item on the storage container in which the consumed item had been stored.

### CROSS REFERENCE TO RELATED APPLICATIONS

This application is based upon and claims the benefit of priority from Japanese patent application No. 2022-098765, filed on Jun. 20, 2022, the disclosure of which is incorporated herein in its entirety by reference.

### BACKGROUND

The present disclosure relates to a management apparatus, a management method, and program.

In recent years, technology has been developed for the automation of logistics. For example, International Patent Publication No. WO 2017/168678 discloses that in a warehouse, a robot can efficiently perform shipping and replenishment works by transporting items to a predetermined storage location.

### SUMMARY

The inventors studied a technique that uses a robot to replenish items when the items are consumed in a storage container, and found the following problem. When items that are frequently consumed are stored in a plurality of storage containers, replenishment works occur for all the storage containers, resulting in reduced efficiency of replenishment works. Thus, techniques to enable efficient replenishment have been desired.

The present disclosure has been made against the background of the above circumstances, and an object thereof is to provide a management apparatus, a management method, and a program that can suppress inefficient replenishment.

In an aspect of the present disclosure to achieve the above object, a management apparatus includes: an information acquisition unit configured to acquire, for each item, frequency information, the frequency information indicating a frequency of consumption; an allocation determination unit configured to determine allocation of the item to a storage container for storing the item based on the frequency of consumption of the item; and an instruction unit configured to instruct a robot to perform an action for replenishing the consumed item on the storage container in which the consumed item had been stored.

According to this management apparatus, the items are stored in the storage container selected according to the frequency of consumption of the items. Therefore, it is possible to prevent the items with regard to which there is high frequency of consumption from being distributed and stored in various storage containers, and it is possible to suppress the occurrence of replenishment works for the plurality of storage containers by the robot. This suppresses inefficient replenishment.

In the above aspect, the allocation determination unit may determine the allocation of the item to the storage container for storing the item further based on compatibility between the items.

With such a configuration, it is possible to avoid that the items that are not desirable to be included in the same box from being included in the same storage container, which improves the convenience of the user.

In the above aspect, the allocation determination unit may determine the allocation of the item to the storage container for storing the item further based on the number of storage containers available.

With such a configuration, even if the number of storage containers available is limited, the storage containers to which the items are allocated can be determined.

In the above aspect, the replenishment of the consumed item may be carried out by replacing the storage container in which the consumed item had been stored with a storage container in which a predetermined number of the items have been stored, and the management apparatus may further include a timing determination unit configured to determine a timing of the replacement of the storage container for the replenishment based on whether or not the number of any of the items allocated to the same storage container has become less than or equal to a predetermined number.

With such a configuration, the storage container will be replaced when the number of any one of the items allocated to the same storage container is reduced to less than or equal to the predetermined number. Therefore, inconvenience to the user due to shortage can be suppressed for any of the items.

In the above aspect, the replenishment of the consumed item is carried out by replacing the storage container in which the consumed item had been stored with a storage container in which a predetermined number of the items have been stored, and the management apparatus further includes a timing determination unit configured to determine a timing of the replacement of a first storage container for the replenishment based on the amount of consumption of the items allocated to the first storage container and the amount of consumption of spare items stored in a second storage container, the second storage container storing the spare items for the items stored in the first storage container.

With such a configuration, even if the number of remaining items in one storage container is reduced, the container need not be immediately replaced, so that the frequency of replacing the storage container can be reduced.

In the above aspect, the timing determination unit may further adjust the timing of the replacing the second storage container so that a replacement frequency of the second storage container becomes less than a replacement frequency of the first storage container.

With such a configuration, the frequency of replacing the second storage container can be less than the frequency of replacing the first storage container, and thus the frequency of replacing the storage container can be further reduced.

In another aspect of the present disclosure to achieve the above object, a management method performed by a management apparatus includes: acquiring, for each item, frequency information, the frequency information indicating a frequency of consumption; determining allocation of the item to a storage container for storing the item based on the frequency of consumption of the item; and instructing a robot to perform an action for replenishing the consumed item on the storage container in which the consumed item had been stored.

According to such a management method, the items are stored in the storage container selected according to the frequency of consumption of the items. Therefore, it is possible to prevent the items with respect to which there is high frequency of consumption from being distributed and stored in various storage containers, and it is possible to suppress the occurrence of replenishment works for the plurality of storage containers by the robot. This suppresses inefficient replenishment.

In another aspect of the present disclosure to achieve the above object, a program causes a computer to execute: acquiring, for each item, frequency information, the frequency information indicating a frequency of consumption; determining allocation of the item to a storage container for storing the item based on the frequency of consumption of the item; and instructing a robot to perform an action for replenishing the consumed item on the storage container in which the consumed item had been stored.

According to this program, the items are stored in the storage container selected according to the frequency of consumption of the items. Therefore, it is possible to prevent the items with regard to which there is high frequency of consumption from being distributed and stored in various storage containers, and it is possible to suppress the occurrence of replenishment works for the plurality of storage containers by the robot. This suppresses inefficient replenishment.

According to the present disclosure, it is possible to provide a management apparatus, a management method, and a program that can suppress inefficient replenishment.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing an example of a configuration of an item management system according to a first embodiment;

FIG. 2 is a schematic front view showing an example of a configuration of a shelf accommodating storage boxes;

FIG. 3 is a schematic side view showing an example of a configuration of a picking robot;

FIG. 4 is a schematic side view showing an example of a configuration of a transport robot;

FIG. 5 is a block diagram showing an example of a functional configuration of a management apparatus according to the embodiment;

FIG. 6 is a table showing a specific example of information acquired by an information acquisition unit;

FIG. 7 is a block diagram showing an example of a hardware configuration of the management apparatus according to the embodiment;

FIG. 8 is a flowchart showing an example of an operation related to allocation performed by the management apparatus according to the embodiment; and

FIG. 9 is a flowchart showing an example of an operation related to replenishment performed by the management apparatus according to the embodiment.

### DESCRIPTION OF EMBODIMENTS

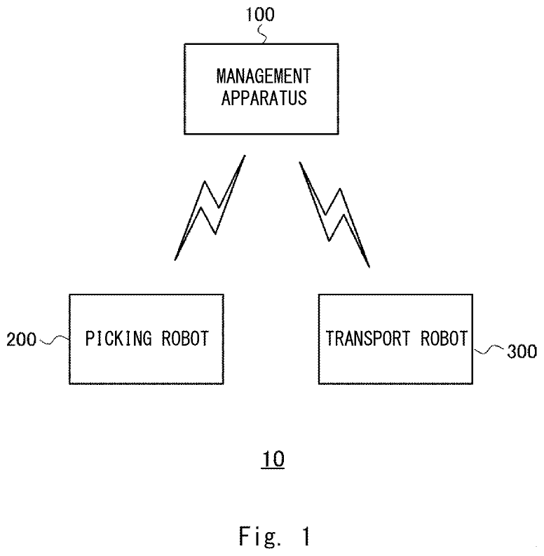

FIG. 1 is a schematic diagram showing an example of a configuration of an item management system 10 according to an embodiment. The item management system 10 performs processing to manage storage of items using storage containers and also performs processing to replenish consumed items when the items stored in the storage containers are consumed. It should be noted that the storage container is for storing the items. In this embodiment, as an example, the storage container is a storage box, which will be described later in detail, but is not limited to this as long as the storage container can store the items.

As shown in FIG. 1, the item management system 10 includes a management apparatus 100, a picking robot 200, and a transport robot 300. The management apparatus 100 is connected wirelessly or wired to enable communication with each of the picking robot 200 and the transport robot 300. If necessary, the picking robot 200 and the transport robot 300 may also be connected wirelessly or wired to enable communication.

The management apparatus 100 is for managing the storage of items and performing control processing for replenishing the consumed items. Details of the management apparatus 100 will be described later. The storage box stores the items used by a user. The items stored in the storage box are consumable items such as food and daily necessities. The user takes out and uses the items stored in the storage boxes. Then, the number of items stored in the storage boxes is reduced. That is, the items are consumed. In this embodiment, the storage box is accommodated in a shelf placed in, for example, the user's living space, but the storage box need not necessarily be accommodated in the shelf.

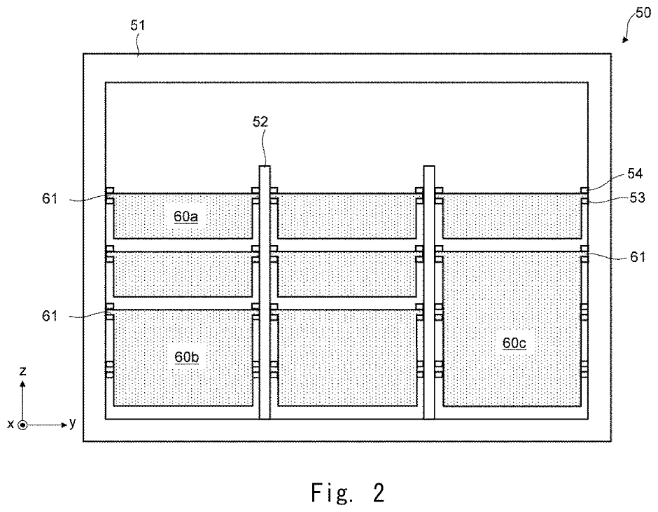

FIG. 2 is a schematic front view showing an example of a configuration of a shelf 50 accommodating the storage boxes. The shelf 50 accommodates the storage boxes and is installed, for example, in a living space of a house. In the present specification, the house includes an apartment house, an office building, etc., and the living space includes an office space. As shown in FIG. 2, the shelf 50 includes storage boxes 60a to 60c for storing consumable items. The sizes of the storage boxes 60a to 60c differ from each other. Hereinafter, the storage boxes 60a to 60c are referred to as storage boxes 60 when they are mentioned without distinction.

As shown in FIG. 2, the shelf 50 includes a housing 51, partition plates 52, rails 53, and locking mechanisms 54.

The right-handed xyz rectangular coordinates shown in FIG. 2 are used for convenience in explaining the positional relationships of the components. Normally, the positive z-axis is vertically upward, and the xy-plane is a horizontal plane. FIG. 2 is a front view, but for ease of understanding, the storage boxes 60 are hatched. Furthermore, the configuration of the shelf 50 shown in FIG. 2 is only an example, and shelves with other configurations that can accommodate storage boxes may be used.

The housing 51 constitutes an outer frame of the shelf 50. In the example shown in FIG. 2, the housing 51 has a frame structure in which a top plate provided on the positive direction side of the z-axis, a bottom plate provided on the negative direction side of the z-axis, and side plates provided on the positive direction side of the y-axis and the negative direction side of the y-axis are integrally formed. That is, the front and the back faces of the housing 51 are open so that the storage boxes 60 can be taken in and out.

Openable doors may be provided on the front and the back faces of the opened housing 51. The front face or the back face of the housing 51 may be closed.

As shown in FIG. 2, the partition plates 52 are provided parallel to the side plates constituting the housing 51 (i.e. parallel to the xz plane) and provided from the front face to the back face of the open housing 51.

Here, the partition plates 52 are provided so that the space between the side plates of the housing 51 and the adjacent partition plates 52 and the space between the partition plates 52 become equal.

In the example of FIG. 2, two partition plates 52 are provided and three rows of storage places for the storage boxes 60 are provided, but the number of partition plates 52 is not limited in any way. Moreover, the partition plates 52 may not be provided, and one row of the storage places for the storage boxes 60 may be provided.

As shown in FIG. 2, a plurality of pairs of the rails 53 extend in the depth direction (x-axis direction) and are equally spaced in the height direction (z-axis direction) on an inner surface of the housing 51 and the partition plates 52. Here, the rails 53 are provided to rise almost vertically from the inner surface of the housing 51 and the partition plates 52. In the example of FIG. 2, four pairs of the rails 53 are provided in each row to accommodate four minimum-size storage boxes in each row.

It should be noted that the number of rails 53 is not limited in any way. The rails 53 may be extended discontinuously in the depth direction (x-axis direction) as long as they can support the storage boxes 60. Alternatively, instead of the rails 53, short supports may be arranged to be aligned in the depth direction (x-axis direction).

Brims 61 are provided on both sides of the storage box 60, and the brims 61 are supported by the pair of rails 53 adjacent and opposed to each other from below, whereby the storage boxes 60 are supported in the shelf 50. Each of the brims 61 is a protrusion protruding outward from the storage box 60 in the width direction. The brim 61 is provided on both sides of the storage box 60 from the front face to the back face. The storage box 60 can be taken in and out by sliding the brims 61 on the pair of rails 53.

Thus, the shelf 50 can accommodate all of the pre-defined multi-sized storage boxes 60 while slidably supporting them along each pair of rails 53.

The locking mechanism 54 is provided on an upper side of each pair of rails 53. The locking mechanism 54 locks the storage box 60 accommodated in the shelf 50 and its lid (not shown) to the housing 51 to prevent the theft of the storage box 60 and the consumable items stored inside it. The shelf 50 need not necessarily have the locking mechanism 54. The storage box 60 need not necessarily have a lid.

In this embodiment, all of the storage boxes 60a to 60c of a pre-defined plurality of sizes have the same width in the y-axis direction and the same depth in the x-axis direction. On the other hand, the storage boxes 60a to 60c have different heights in the z-axis direction. The height of the smallest storage box is designed to match a spacing between the rails 53 adjacent to each other in the z-axis direction. Obviously, the height of the smallest storage box 60a is smaller than the spacing between the rails 53. The height of the medium-sized storage box 60b is designed to be approximately twice the height of the storage box 60a. The height of the largest storage box 60c is also designed to be approximately three times the height of the storage box 60a.

That is, each of the heights of the pre-defined multi-sized storage boxes to 60c is designed to be approximately an integral multiple of the distance between the rails 53 adjacent to each other in the z-axis direction.

In the example shown in FIG. 2, there are three different storage box sizes, but one, two, or more than four storage boxes may be used. In the example shown in FIG. 2, in addition to the storage boxes 60a to 60c, for example, a storage box having a height approximately four times the height of the storage box 60a may be provided separately.

Consumable items such as food items and daily necessities are stored inside the storage boxes 60. The consumable items stored inside the storage boxes are replenished by a first replenishment method or a second replenishment method at a timing determined by the timing determination unit 103 described later. The first replenishment method is a method for individually replenishing items to a storage box 60 in which the items have been consumed using a picking robot 200. That is, the first replenishment method is a method for replenishing items by the picking robot 200 adding items in the storage box 60 in which the number of items is smaller than that in an initial state. The items are repeatedly added until the number of items reaches a predetermined number (the number in the initial state). In the first replenishment method, another robot (e.g., a transport robot 300 that will be described later) may be further used to transport the storage box 60. Further, the second replenishment method is a method for replacing a storage box where items have been consumed by a storage box 60 where a predetermined number of items are stored. That is, the second replenishment method is a method in which items are replenished by replacing a first storage box 60 in which the number of items is smaller than that in the initial state by a second new storage box in which a predetermined number of items (the number of items in the initial state) are stored. That is, in this method, a picking robot 200 is not used. In the second replenishment method, another robot (e.g., a transport robot 300 that will be described later) may be used to transport the storage box 60.

Next, the picking robot 200 will be described. The picking robot 200 picks up items and replenishes them to the storage boxes 60 based on instructions from the management apparatus 100. The picking robot 200 may pick up items for sorting the items. That is, the picking robot 200 may be utilized to achieve the allocation determined by the allocation determination unit 102 described later.

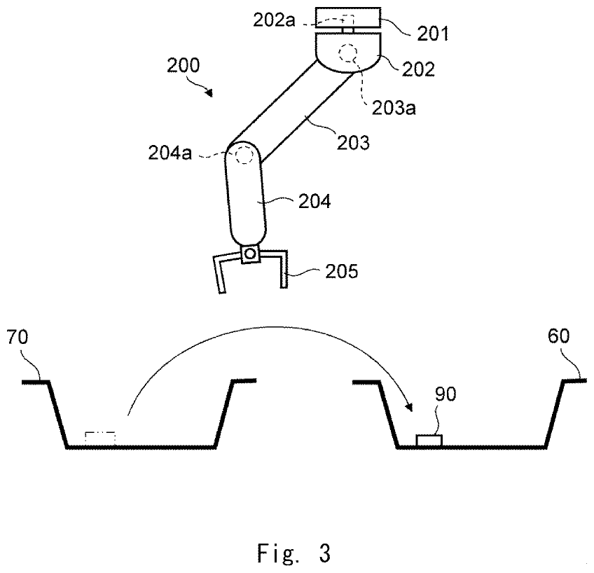

FIG. 3 is a schematic side view showing an example of a configuration of the picking robot 200.

The picking robot 200 is a manipulator including a base part 201, a link root part 202, a first link 203, a second link 204, and an end effector 205. The picking robot 200 picks up an item 90 by the end effector 205 and places the item in the storage box 60. FIG. 3 shows how the item 90 is put in the storage box from a storage box 70 for delivering the item 90. The storage box 60 may be used as the storage box 70 which is for delivering the items. The item 90 is put in the storage box 70 in advance at a distribution center or the like.

The configuration of the end effector 205 is not limited as long as the items can be picked up by the end effector 205. For example, the end effector 205 may pick up the item by holding the item, or it may pick up the item by sucking the item. In the example shown in FIG. 3, the link mechanism is composed of two links, the first link 203 and the second link 204, but the link mechanism may be composed of three or more links.

The base part 201 is fixed at a specified place. For example, the base part 201 may be fixed to a top plate constituting the housing 51 of the shelf 50, or it may be fixed to a wall or a floor surface in the living space of the house.

The link root part 202 is coupled to the base part 201 with a rotary shaft 202a interposed therebetween so as to be rotatable about the rotary shaft 202a. The rotary shaft 202a of the link root part 202 is an axis perpendicular to the plane on which the base part 201 is fixed. The link root part 202 is rotationally driven by a motor (not shown) or the like.

The first link 203 is rotatably coupled to the link root part 202 with a first joint 203a provided at the rear end of the first link 203 interposed therebetween.

The second link 204 is also rotatably coupled to a leading end of the first link 203 with a second joint 204a provided at the rear end of the second link 204 interposed therebetween. The end effector 205 is coupled to a leading end of the second link 204.

Here, the rotary shaft of the first joint part 203a and the second joint part 204a are parallel to the plane on which the base part 201 is fixed. In the example shown in FIG. 3, the height of the end effector 205 can be changed by rotating the first link 203 and the second link 204. The first link 203 and the second link 204 are respectively rotationally driven by motors and the like not shown.

With such a configuration, the item 90 can be replenished in the storage box 60 by the picking robot 200.

Although not shown, the picking robot 200 includes a processor such as a CPU (Central Processing Unit) and a memory in which various control programs, data, and the like are stored. That is, the picking robot 200 has a function as a computer and executes various control processes based on the above various control programs and the like.

Next, the transport robot 300 will be described. The transport robot 300 transports the storage boxes 60 and the storage box 70 based on instructions from the management apparatus 100.

In this embodiment, the transport robot 300 performs the following transportation to replenish the items by the picking robot 200. The transport robot 300 transports the storage boxes 60 accommodated in the shelf 50 to a work area of the picking robot 200. In addition, the transport robot 300 transports the storage box 70 in which the items are put in advance from a predetermined place such as a distribution center to the work area of the picking robot 200. When the work of replenishing the items by the picking robot 200 is completed, the transport robot 300 transports the storage box 60 with the items replenished to a predetermined accommodating position in the shelf 50. Further, the transport robot 300 transports the storage box 70 from which the items have been removed to a predetermined place such as the distribution center.

Also, in this embodiment, the transport robot 300 performs the following transportation for replenishment by replacing the storage box 60 from which the items have been consumed with the storage box 60 in which the predetermined number of the items have been stored. The transport robot 300 transports the storage box 60 in which the predetermined number of the items have been stored from a predetermined place, such as the distribution center, to a predetermined accommodating position in the shelf 50. The transport robot 300 also transports the storage box 60 to be replaced, accommodated in the shelf 50, to a predetermined place, such as the distribution center.

The transport robot 300 may transport the storage box 60 or the storage box 70 for sorting the items by the picking robot 200. That is, the transport robot 300 may be utilized to achieve the allocation determined by the allocation determination unit 102 described later.

The storage box may be transported by a plurality of the transport robots 300 by relaying the storage box. For example, the transportation may be achieved using the transport robot 300 in charge of transport between the distribution center and the vicinity of the living space and another transport robot 300 performing transportation inside the living space.

Thus, in this embodiment, the transport robot 300 transporting the storage box is used, and the items are replenished by the picking robot or by replacing the storage box, but the transport robot 300 may not necessarily be used. That is, the transportation of the storage box may be carried out by a person (worker).

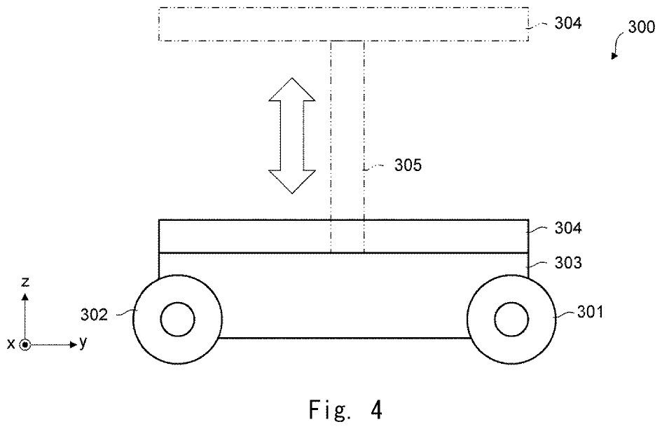

FIG. 4 is a schematic side view showing an example of the configuration of the transport robot 300. The transport robot 300 shown in FIG. 4 is an autonomous traveling vehicle that takes the storage boxes 60 in and out of the shelf 50 and transports the storage boxes 60. It should be noted that the transport robot 300 may perform similar work on the storage box 70.

As shown in FIG. 4, the transport robot 300 includes wheels 301 and 302, a body part 303, a top plate 304, and a support post 305.

The two pairs of wheels 301 and 302 are rotatably fixed to a lower part of the body part 303 and are driven by a driving source (not shown) such as a motor.

As shown in FIG. 4, the top plate 304 is coupled to the body part 303 with the extendable support post 305 interposed therebetween. The top plate 304 is coupled to the upper end of the support post 305, and the transport robot 300 places the storage box 60 on the top plate 304 to transport it.

The support post 305 has, for example, a telescopic expansion mechanism and is expanded and contracted by a driving source (not shown) such as a motor. The height of the top plate 304 can be changed by changing the length of the support post 305, as shown by a blank arrow in FIG. 4. Therefore, the storage box can be taken in and out at any accommodated place in the shelf 50.

Here, the transport robot 300 includes a manipulator (not shown), for example, and the storage box 60 is moved from the shelf 50 to the top plate 304 by the manipulator. Then, the storage box 60 on the top plate 304 is moved to the shelf 50 by the manipulator.

Although not shown, the transport robot 300 also includes a processor such as a CPU (Central Processing Unit) and a memory in which various control programs, data, and the like are stored. That is, the transport robot 300 also has a function as a computer and executes various control processes based on the above various control programs and the like.

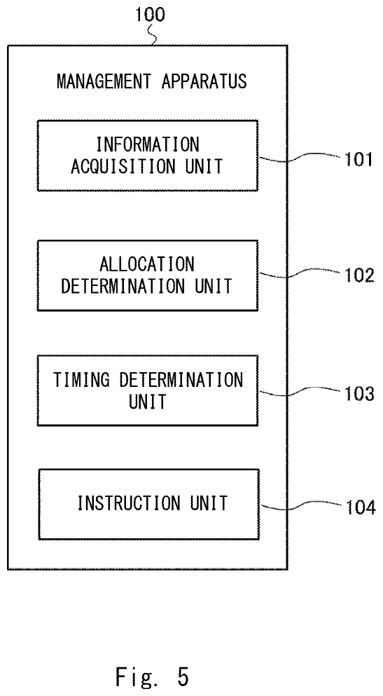

Next, details of the management apparatus 100 will be described. FIG. 5 is a block diagram showing an example of the functional configuration of the management apparatus 100. As shown in FIG. 5, the management apparatus 100 includes an information acquisition unit 101, an allocation determination unit 102, a timing determination unit 103, and an instruction unit 104.

For each item to be stored in the storage box 60, the information acquisition unit 101 acquires frequency information, which is information indicating a frequency of consumption. The information acquisition unit 101 may acquire the frequency information by any method. For example, the information acquisition unit 101 may acquire the frequency information by receiving it from any other device or by reading it from a storage device such as the memory of the management apparatus 100. The frequency information is generated in advance by any method. For example, the frequency information may be generated by periodically checking the number of remaining items by performing image recognition processing on images inside the storage boxes 60 captured by cameras. In this case, the management apparatus 100 may periodically receive the images inside the storage box 60 captured by the cameras to generate the frequency information. That is, the management apparatus 100 may include a frequency information generation unit that analyzes the received images and generates the frequency information. The method of generating the frequency information is not limited to the method described above. For example, the frequency information may be generated based on history information about consumption of the items entered by the user via an input device such as a keyboard or a pointing device. Again, the such generation of the frequency information may be performed by the management apparatus 100.

In addition, the information acquisition unit 101 acquires category information indicating a category of each item to be stored in the storage boxes 60. The category indicated by the category information is, for example, a category based on the use of the item. Specifically, those categories are, but are not limited to, food, toilet items, kitchen items, nursing care items, etc., and the category information may indicate more detailed categories. The information acquisition unit 101 may acquire pre-defined category information for each item by any method. For example, the information acquisition unit 101 may acquire the category information by receiving it from any other device, by reading it from a storage device such as a memory of the management apparatus 100, or by referring to a database.

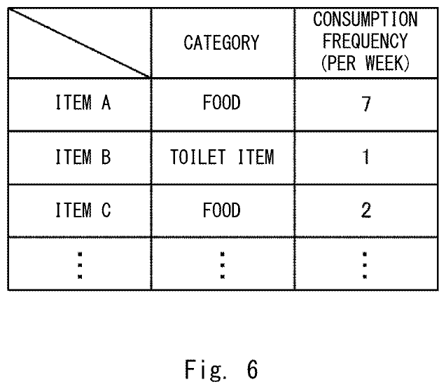

FIG. 6 is a table showing specific examples of information acquired by the information acquisition unit 101. In this embodiment, the category information and the frequency information are acquired for each item as described above. In the example shown in FIG. 6, only information about three kinds of items (Article A, Article B, Article C) is shown, but when more kinds of items are stored in the storage boxes 60 (shelf 50), the information acquisition unit 101 also acquires information about them. In the example shown in FIG. 6, the frequency information indicates the number of consumption per week, but it need not necessarily be the number of consumption per week. That is, the frequency information can be expressed as the number of consumption per predetermined unit time. In this way, the frequency information can only be information that can specify the rate of consumption, and its specific definition is not limited. It should be noted that the information acquisition unit 101 may acquire additional information as necessary. For example, the information acquisition unit 101 may acquire additional information indicating the number of storage boxes 60 available in the shelf 50.

The allocation determination unit 102 determines the allocation of the items to the storage boxes 60. Thus, each item is stored in the storage box 60 according to the allocation determined by the allocation determination unit 102. In this embodiment, the allocation determination unit 102 determines the allocation based on the consumption frequency of each item, the compatibility between the items, and the number of storage boxes 60 available, but the allocation may be determined based on at least the consumption frequency. That is, the allocation determination unit 102 may not necessarily determine the allocation based on the compatibility between the items. Similarly, the allocation determination unit 102 may not necessarily determine the allocation based on the number of the storage boxes 60 available.

The allocation determination unit 102 first groups the items according to the consumption frequency of each item. In particular, the allocation determination unit 102 performs grouping of the items so that the items whose consumption frequency is greater than or equal to a predetermined threshold belong to the same group. Here, this predetermined threshold is for extracting the items whose consumption frequency is high, and may be a preset value or may be calculated from a statistic (e.g., an average value or the like) of the consumption frequency of each item. That is, the allocation determination unit 102 at least groups the items whose consumption frequency is high so that they belong to the same group. The allocation determination unit 102 may classify the items whose consumption frequency is less than the predetermined threshold into the same group or into a plurality of groups. The allocation determination unit 102 determines the allocation of the items to the storage boxes 60 so that the items classified in the same group are stored in the same storage box 60. Therefore, the allocation determination unit 102 determines the allocation so that the items consumed at high frequency are stored in the same storage box 60.

However, as described above, in this embodiment, the allocation is determined in consideration of the compatibility between the items. This will be explained. Due to the respective natures of the different items, it may not be desirable to store them in the same storage box 60. For example, the user may feel reluctant to store food and toilet items in the same storage box 60. Therefore, in this case, it is preferable to store items whose category is food and items whose category is toilet items in different storage boxes 60. Thus, in this embodiment, the allocation determination unit 102 corrects the grouping of items according to the frequency of consumption based on the compatibility between the items. That is, the allocation determination unit 102 corrects the grouping of the items so that the items with poor compatibility are classified as being in separate groups. Specifically, the allocation determination unit 102 performs, for example, the following processing. The allocation determination unit 102 refers to the category information and specifies a degree of mismatch between the items. The degree of mismatch is defined in advance for each combination of categories. The degree of mismatch is an index value that indicates the degree of tolerance of the user for placing the items in the same storage box 60. The degree of mismatch may be set by the user. If the degree of mismatch between the items classified in the same group is greater than or equal to a predetermined threshold, the allocation determination unit 102 corrects the grouping of the items so that the items belong to separate groups. For example, the allocation determination unit 102 may divide a group and increase the number of groups so that the items with poor compatibility are classified as being in separate groups, or move items of one category in a group to another existing group so that the items with poor compatibility are classified as being in separate groups.

In addition, as described above, in this embodiment, the allocation is determined in consideration of the number of storage boxes 60 available. This will be explained. If, depending on the results of the grouping described above, the number of storage boxes 60 available is not large enough, the number of storage boxes 60 required for the storage of items according to the allocation based on the results of the grouping may exceed the number of storage boxes 60 available. In such a case, the storage according to the allocation determined by the allocation determination unit 102 cannot be achieved. Therefore, in this embodiment, the allocation determination unit 102 corrects the grouping of the items so that the number of storage boxes 60 required for the storage according to the allocation based on the grouping becomes less than or equal to the number of storage boxes 60 available. Specifically, for example, the allocation determination unit 102 performs the grouping again by changing the value of the aforementioned threshold. That is, the allocation determination unit 102 resets the threshold and performs the grouping again. For example, if the compatibility is taken into account, a plurality of items that previously belonged to one group in the grouping according to the frequency of consumption are reclassified in separate groups. In this case, the number of storage boxes 60 required will increase, potentially exceeding the number of storage boxes 60 available. In such a case, for example, the allocation determination unit 102 may prevent the correction of the group based on the compatibility by resetting the value of the above predetermined threshold to be compared with the degree of mismatch, i.e., by changing the value of the threshold from the initial set value to a higher value. In addition, for example, the following situations may occur as a result of the grouping based on the frequency of consumption using the threshold of the initial set value. That is, if one storage box 60 is used only for items determined to be consumed at high frequency, the remaining storage boxes 60 available may not be sufficient to store all items consumed at other frequencies. In this case, it is preferable to correct the grouping of the items so that more items are stored in the one storage box 60. Therefore, in such a case, for example, the allocation determination unit 102 may reset the value of the above predetermined threshold to be compared with the frequency of consumption, i.e., may change the value of the threshold from the initial set value to a lower value, so that the number of items determined to be consumed at high frequency (which is, the number of items stored in the above one storage box 60) increases.

When the final allocation is determined by the allocation determination unit 102, the storage of items according to this allocation is achieved. In this embodiment, such storage is achieved by, for example, the instruction unit 104 outputting instructions to the picking robot 200 and the transport robot 300, as described later, and instead a person (worker) may achieve such storage.

The timing determination unit 103 determines a timing of replenishing the stored items according to the allocation determined by the allocation determination unit 102. The timing determination unit 103 determines the timing of replenishing the items based on, for example, the amount of consumption of the items. The amount of consumption can be specified by any method in a manner similar to the frequency information. The timing of this replenishment may be the timing of the first replenishment method (method of individually replenishing items using the picking robot 200) or the timing of the second replenishment method (method of replenishing items by replacing the storage box 60).

In this embodiment, especially when replenishment is made by replacing the storage box 60, the replenishment may be performed at the following timing. That is, the timing determination unit 103 may determine the timing of replacing the storage box 60 for replenishment based on whether or not any of the items allocated to the same storage box 60 is less than or equal to a predetermined number. For example, the timing determination unit 103 determines that the timing of replacing the storage box 60 has come when any of the items is less than or equal to the predetermined number among the plurality of kinds of items stored in the storage box 60 in which the items determined to be consumed at high frequency are stored. In this case, the storage box 60 is replaced with a new storage box 60 in which the predetermined number of each of the plurality of kinds of items is stored. By determining the timing in this way, the storage box 60 will be replaced when the number of any one of the items allocated to the same storage box 60 is reduced to less than or equal to the predetermined number. Therefore, inconvenience to the user due to shortage can be suppressed for any of the items. That is, since the replacement is performed focusing on the consumption of the individual items allocated to the same storage box 60, the replenishment timing can be determined more appropriately than when the replacement is performed focusing on the total consumption of all the items allocated to the same storage box 60.

The instruction unit 104 outputs instructions to the picking robot 200 and the transport robot 300. The instruction unit 104 at least instructs the robot to perform an action for replenishing the consumed items for the storage box 60 in which the items have been consumed. Specifically, the instruction unit 104 at least instructs the transport robot 300 to transport the storage boxes 60, 70 to achieve the replenishment by the first replenishment method or the second replenishment method. That is, the instruction unit 104 notifies the transport robot 300 of an instruction to transport the storage box 60 or the storage box 70. In the case of achieving the replenishment by the first replenishment method, the instruction may be an instruction to transport the storage box 60 in which the items have been consumed to the work area of the picking robot 200, or an instruction to transport the storage box 70 in which the items have been put in advance at a predetermined place such as the distribution center to the work area of the picking robot 200. The instruction may also be an instruction to transport the storage box to a predetermined place such as the distribution center after the work of the picking robot 200 has been completed, or an instruction to transport the storage box in which the items have been replenished to the shelf 50. Further, in the case of achieving the replenishment by the second replenishment method, this instruction may be an instruction to transport the storage box 60 in which the items have been put in advance at a predetermined place such as the distribution center to the shelf 50, or an instruction to transport the storage box 60 in which the items have been consumed from the shelf 50 to a predetermined place such as the distribution center. The instruction unit 104 may further instruct the picking robot 200 to achieve the replenishment by the first replenishment method. That is, the instruction unit 104 notifies the picking robot 200 of an instruction to transfer the item from the storage box 70 in which the items have been put in advance to the storage box 60 in which the items have been consumed. The instruction unit 104 instructs the robot to perform replenishment at the timing determined by the timing determination unit 103.

The instruction unit 104 may also output instructions to the picking robot 200 and the transport robot 300 to achieve the storage of the items according to the allocation determined by the allocation determination unit 102. In this case, the instruction unit 104 may, for example, instruct the picking robot 200 and the transport robot 300 to replace the items already stored in the storage box 60 according to the determined allocation. For example, the instruction unit 104 notifies the transport robot 300 of an instruction to transport the storage box 60 to the work area of the picking robot 200. The instruction unit 104 also notifies the picking robot 200 of an instruction to move the items from one storage box 60 to another storage box 60 in order to perform sorting according to the determined allocation.

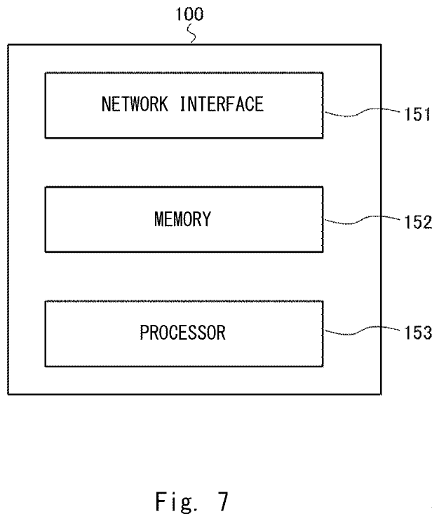

FIG. 7 is a block diagram showing an example of a hardware configuration of the management apparatus 100. As shown in FIG. 7, the management apparatus 100 includes a network interface 151, a memory 152, and a processor 153.

The network interface 151 is used to communicate with any apparatus, such as the picking robot 200 and the transport robot 300. The network interface 151 may include, for example, a network interface card (NIC).

The memory 152 is composed of, for example, a combination of a volatile memory and a non-volatile memory. The memory 152 is used to store programs executed by the processor 153, data used for various processes of the management apparatus 100, and so on.

The processor 153 reads the programs from the memory 152 and executes them to perform processing of each component shown in FIG. 5. The processor 153 may be, for example, a microprocessor, a Micro Processor Unit (MPU), or a Central Processing Unit (CPU). The processor 153 may include a plurality of processors.

In this way, the management apparatus 100 has a function as a computer.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

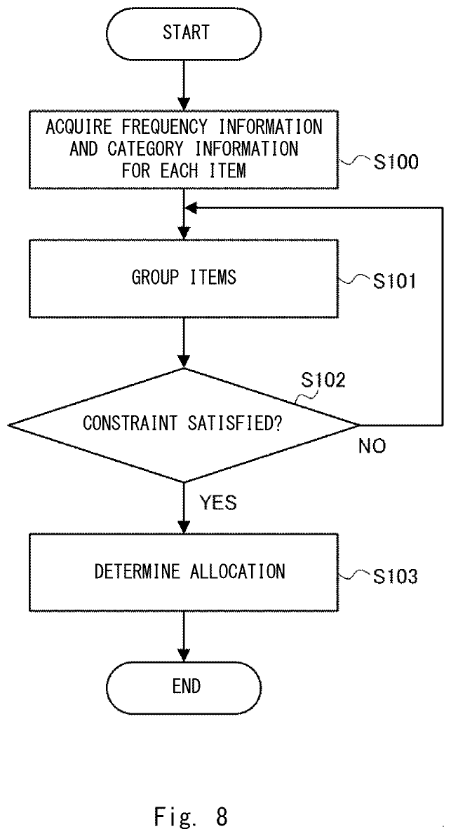

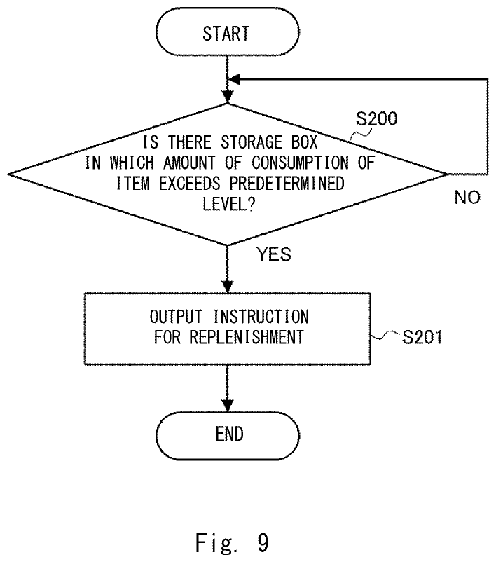

Next, a flow of an operation of the management apparatus 100 is described. FIG. 8 is a flowchart showing an example of an operation of the management apparatus 100 with respect to the allocation. FIG. 9 is a flowchart showing an example of the operation of the management apparatus 100 with respect to the replenishment.

First, the flow of the operation of the management apparatus 100 with respect to the allocation is explained with reference to FIG. 8.

In Step S100, the information acquisition unit 101 acquires the frequency information and the category information for each item.

Next, in Step S101, the allocation determination unit 102 groups the items.

Next, in Step S102, the allocation determination unit 102 determines whether or not the group created in Step S101 satisfies a constraint of the compatibility between the items and a constraint of the number of storage boxes 60 available. If the constraints are not satisfied (NO in Step S102), the processing returns to Step S101, where the correction of grouping is performed. If the constraints are satisfied (YES in Step S102), the processing transitions to Step S103.

In Step S103, the allocation determination unit 102 determines the allocation of the items to the storage box 60 so that the items classified into the same group are stored in the same storage box 60.

As described above, after Step S103, the instruction unit 104 may output instructions to the picking robot 200 and the transport robot 300 based on the allocation determined in Step S103.

Next, a flow of the operation of the management apparatus 100 with respect to the replenishment is described with reference to FIG. 9. For example, the management apparatus 100 performs the following processing after the storage according to the allocation determined by the allocation determination unit 102 is achieved. In Step S200, the timing determination unit 103 determines whether or not there is a storage box 60 in which the amount of consumption of the item exceeds a predetermined level. If such a storage box 60 is present (YES in Step S200), the timing determination unit 103 determines that the timing for replenishing the storage box 60 has come, and processing transitions to Step S201. If such a storage box 60 is not present, Step S200 is periodically repeated.

In Step S201, the instruction unit 104 outputs instructions for the replenishment to the picking robot 200 and the transport robot 300.

The embodiment has been described as above. According to the management apparatus 100, the items are stored in one of the storage boxes 60 selected according to the frequency of consumption of the items. Therefore, it is possible to prevent the items with regard to which there is high frequency of consumption from being distributed and stored in various storage boxes 60, and it is possible to suppress the occurrence of replenishment works for the plurality of storage boxes 60 by the robot. This suppresses inefficient replenishment, and the robot can be operated efficiently. Especially, in this embodiment, the allocation determination unit 102 further determines the allocation of the items to the storage box 60 for storing the items based on the compatibility between the items. Therefore, it is possible to avoid that the items that are not desirable to be included in the same box from being included in the same storage box 60, which improves the convenience of the user. In this embodiment, the allocation determination unit 102 further determines the allocation of the items to the storage boxes 60 for storing the items based on the number of storage boxes 60 available. For this reason, even if the number of storage boxes 60 available is limited, it is possible to determine the storage box 60 to which the items are allocated.

### Modified Example of Embodiment

Next, a modified example of the embodiment will be described. The modified example differs from the first embodiment in that the same items are stored in both the main storage box 60 (first storage box 60) and a spare storage box 60 (second storage box 60). That is, at least for the storage box 60 in which the items determined to be consumed at high frequency are stored, another storage box 60 for storing spare items is also prepared. That is, the spare storage box 60 (second storage box 60) is for storing the spare for the items stored in the main storage box 60 (first storage box 60). The items stored in the spare storage box 60 may be predetermined to be consumed after all the items in the main storage box 60 are consumed.

In this modified example, especially when items are replenished by replacing the storage box 60, the replenishment may be performed at the following timing. Specifically the timing determination unit 103 may determine the timing of replacement of the main storage box 60 for the purpose of replenishment based on the amount of consumption of the items allocated to the main storage box 60 and the amount of consumption of the spare items stored in the spare storage box 60. For example, when the sum of the amount of consumption in the main storage box 60 and the amount of consumption in the spare storage box 60 for any of the items stored in the main storage box 60 exceeds a predetermined level, the timing determination unit 103 determines that the timing of replacing the main storage box has come. In this case, the main storage box 60 is replaced with a new storage box 60 in which the predetermined number of each item is stored. By determining the timing of replenishing the items in this way, even if the number of remaining items in the main storage box 60 is reduced, the main storage box 60 need not be immediately replaced, so that the frequency of replacing the main storage box 60 can be reduced.

The spare storage box 60 may be replenished at the same timing as the replenishment of the main storage box 60, but the replenishment timing may be determined as follows. That is, the timing determination unit 103 may adjust the timing of the replacement of the spare storage box 60 so that a replacement frequency of the spare storage box 60 becomes less than a replacement frequency of the main storage box 60. For example, the timing determination unit 103 may wait until the replacement of the main storage box 60 occurs N times (N is an integer greater than or equal to 2) after the spare storage box 60 currently in use is started to be used, even if certain condition to replace the spare storage box 60 is satisfied. For example, if the condition to replace the spare storage box 60 is such that the consumption number of items of any of the items in the spare storage box 60 exceeds a predetermined level, the spare storage box 60 is replaced when this condition is satisfied and the replacement of the main storage box 60 occurs N times after the start of the use of the spare storage box 60. If the spare storage box 60 is used as a spare for the main storage box 60, there are a limited number of opportunities for the items in the spare storage box 60 to be consumed compared to that of the main storage box 60. Therefore, the risk of the items in the spare storage box 60 being out of stock is considered to be low. Therefore, as described above, the timing determination unit 103 may determine the timing of replacement of the storage box to be such that the frequency of the replacement of the spare storage box 60 is reduced. By doing so, the number of occurrences in which the spare storage box 60 are replaced can be reduced while the risk of there being out of stock is reduced. Therefore, the frequency of replacing the storage box 60 can be further reduced.

It should be noted that the present disclosure is not limited to the above embodiment, and it is possible to make appropriate changes without departing from the scope.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A management apparatus comprising:
an information acquisition unit configured to acquire, for each item, frequency information, the frequency information indicating a frequency of consumption;
an allocation determination unit configured to determine allocation of the item to a storage container for storing the item based on the frequency of consumption of the item; and
an instruction unit configured to instruct a robot to perform an action for replenishing the consumed item on the storage container in which the consumed item had been stored.

2. The management apparatus according to claim 1, wherein
the allocation determination unit determines the allocation of the item to the storage container for storing the item further based on compatibility between the items.

3. The management apparatus according to claim 1, wherein
the allocation determination unit determines the allocation of the item to the storage container for storing the item further based on the number of storage containers available.

4. The management apparatus according to claim 1, wherein
the replenishment of the consumed item is carried out by replacing the storage container in which the consumed item had been stored with a storage container in which a predetermined number of the items have been stored, and
the management apparatus further includes a timing determination unit configured to determine a timing of the replacement of the storage container for the replenishment based on whether or not the number of any of the items allocated to the same storage container has become less than or equal to a predetermined number.

5. The management apparatus according to claim 1, wherein
the replenishment of the consumed item is carried out by replacing the storage container in which the consumed item had been stored with a storage container in which a predetermined number of the items have been stored, and
the management apparatus further includes a timing determination unit configured to determine a timing of the replacement of a first storage container for the replenishment based on the amount of consumption of the items allocated to the first storage container and the amount of consumption of spare items stored in a second storage container, the second storage container storing the spare items for the items stored in the first storage container.

6. The management apparatus according to claim 5, wherein
the timing determination unit further adjusts the timing of the replacing the second storage container so that a replacement frequency of the second storage container becomes less than a replacement frequency of the first storage container.

7. A management method performed by a management apparatus comprising:
acquiring, for each item, frequency information, the frequency information indicating a frequency of consumption;
determining allocation of the item to a storage container for storing the item based on the frequency of consumption of the item; and
instructing a robot to perform an action for replenishing the consumed item on the storage container in which the consumed item had been stored.

8. A non-transitory computer readable medium storing a program for causing a computer to execute:
acquiring, for each item, frequency information, the frequency information indicating a frequency of consumption;
determining allocation of the item to a storage container for storing the item based on the frequency of consumption of the item; and
instructing a robot to perform an action for replenishing the consumed item on the storage container in which the consumed item had been stored.
